(19) United States
(12) Patent Application Publication
(10) Pub. No.: US 2013/0068615 A1
(43) Pub. Date: Mar. 21, 2013

(54) Membrane and Sensor with Membrane

(71) Applicants: Thomas Endl, Waldheim (DE); Jörg Tiller, Herdecke (DE); Thilo Trapp, Aliso Viejo, CA (US)

(72) Inventors: Thomas Endl, Waldheim (DE); Jörg Tiller, Herdecke (DE); Thilo Trapp, Aliso Viejo, CA (US)

(73) Assignees: Technische Universität Dortmund, Dortmund (DE); Endress + Hauser Conducta Gesellschaft für Mess- und Regeltechnik mbH + Co. KG, Gerlingen (DE)

(21) Appl. No.: 13/611,268

(22) Filed: Sep. 12, 2012

(30) Foreign Application Priority Data
Sep. 19, 2011 (DE) 10 2011 082 983.0

(51) Int. Cl. C25B 13/04; G01N 27/40; B32B 37/00; B29C 39/00; B05D 1/02; B05D 1/28; B29C 53/00; B29C 47/00; C25B 13/08; B05D 5/00

(52) U.S. Cl. 204/415; 204/295; 204/296; 156/60; 427/256; 427/421.1; 427/428.01; 264/164; 264/176.1; 264/299

(57) ABSTRACT

A membrane, especially for application in a sensor, which membrane includes a biocidal effect. The membrane comprises one or more components of the group consisting of: silver nano particles encapsulated in amphiphilic, core, shell structures, antimicrobial silanes, polymers with an antimicrobial end group, polyquads with modified end groups, and biocidally acting block copolymers. The membrane is resistant against aggressive agents, for example, corrosive or oxidizing cleaning agents, in the case of sterilizing, in the case of autoclaving, in the case of thermal loading and/or in the case of mechanical loading.

The invention relates to a membrane for a sensor, to a sensor, especially an electrochemical sensor, and to a method for manufacturing a membrane, especially a membrane for a sensor.

For monitoring chemical, pharmaceutical, biochemical or biotechnological processes, sensors are frequently applied, which measure parameters relevant for the respective processes. Such parameters can be, for example, the concentrations of certain analytes in the process, but also temperatures, pH values or optical variables such as turbidity or a particle concentration or cell concentration in the medium.

Frequently used as sensors for such applications are electrochemical sensors, for example, potentiometric or amperometric sensors. A series of electrochemical sensors, for example, sensors for determining an analyte concentration in a liquid measured medium, have an electrolyte chamber separated from the measured medium by a membrane. In sensors for determining gas concentration in a liquid, for example, electrochemical O₂, Cl₂, CO₂, H₂S, NH₃ or SO₂ sensors, the membrane serves as a diffusion barrier, through which the analyte diffuses from the measured medium into the electrolyte chamber.

In a process to be monitored, microorganisms—e.g. bacteria, algae or fungi—can be present, which are inclined to form biofilms on surfaces in contact with the process, thus also on the surface of the sensors serving for process monitoring and/or control, especially also on the membrane in contact with the measured medium. Such a biofilm can influence and corrupt the measurement results.

Known from the state of the art—for example, from DE 10 2007 049013 A1—are particular coatings, which should avoid or delay such formation of deposits. There exists, however, the risk that such coatings will not withstand the thermal and chemical loadings of a sterilizing or autoclaving—especially also a sterilization in the process (SIP=Sterilization In Place) or a cleaning with aggressive chemical means—so that, after performing a cleaning and/or sterilization of the type often needed in chemical, biological, pharmaceutical or biotechnological processes, the growth of a biofilm on the sensor membrane is no longer prevented to a sufficient degree.

An object of the present invention is to provide a membrane for sensors of the previously described type, which, on the one hand, possesses an antimicrobial effect (in the following also referred to as a biocidal effect), and which, on the other hand, is sterilizable, cleanable with chemical means and autoclavable, and, in such case, withstands thermal and chemical loadings.

By a membrane, which includes an antimicrobial or biocidal effect, is meant a membrane, which is suitable in a chemical, physical or biological way to destroy harmful organisms, to discourage them, to render them unharmful, to avoid damage due to such organisms, or to combat them in some other manner. In this way, the growth of a biofilm on the membrane is prevented, or at least delayed.

The object is achieved by a membrane, especially a membrane for application in a sensor, which membrane includes a biocidal effect and

comprises one or more components of the group consisting of: silver nano particles encapsulated in amphiphilic, core, shell structures, antimicrobial silanes, polymers with an antimicrobial end group, polyquads with modified end groups and biocidally acting block copolymers.

Such membrane is resistant against aggressive agents, for example, corrosive or oxidizing cleaning agents, in the case of sterilizing, in the case of autoclaving, in the case of thermal loading and/or in the case of mechanical loading.

The membrane can comprise a basic material, especially a thermoplastic or an elastomer, to which the one or more components is covalently bonded.

The basic material can be, for example, a single component or a multicomponent silicone, epoxide resin, polyurethane, polyester, polysulfone, polystyrene, polyacrylate, or a carbon fiber composite material.

In an alternative embodiment, the one or more components can be associated with the basic material via core, shell structures. In a core, shell structure, the component with the actual antibacterial effect is embedded in a core, shell structure—for example, in a polyamino acid structure—which encapsulates it against the environment. The core, shell structures, or the components covalently bonded to the basic material, are in this embodiment embedded in the basic material and/or bonded to the basic material. The components of the membrane with the microbial effect are thus bonded in and/or to the membrane.

The core, shell structures can comprise polyamino acids—for example, polylysine—or their derivatives, or can include functional groups suitable for complex formation, such as, for example, thiol groups or amine groups.

Amphiphilic core, shell structures with silver nano particles can comprise one or more components of the group consisting of: amphiphilic polylysine derivatives, polyethyleneimine derivatives, polyglycerine derivatives, amphiphilic block copolymers, star polymers and comb polymers.

An example of an antimicrobial silane is dimethyloctadecyl[3(trimethoxysilyl)propyl]ammonium chloride (DOTPAC).

At least one polymer of the group consisting of polyethelene glycol, polyoxazolines or polydimethylsiloxanes can form the basis for a polymer with an antimicrobial end group, wherein, for example, quarternary ammonium compounds, phosphonium groups or sulfonium groups can comprise the antimicrobial end group.

A further object of the invention is a sensor—especially an electrochemical sensor—for determining the concentration of an analyte—especially a gas—in a gaseous or liquid, measured medium, wherein the sensor has at least one electrolyte chamber separated from the measured medium by a membrane serving as a diffusion barrier, wherein the membrane is embodied as described above.

The sensor can be an electrochemical sensor, especially a potentiometric or amperometric sensor. The sensor can, for example, be suitable for determining gaseous or highly volatile components, such as, for example, CO₂, O₂, NH₃, H₂S, CO, HCl, HF, HBr, HI, NO, NO₂, NOx, H₂, SO₂, SO₃, CH₄, H₂, Cl₂, ClO₂, HClO, O₃, N₂O.

The invention also includes a method for manufacture of a membrane as described above,

wherein the membrane is formed from a basic material, for example, a single component or multicomponent silicone, epoxide resin, polyurethane, polyester, polysulfone, polystyrene, polyacrylate, or a carbon fiber composite material,

and one or more components selected from the group consisting of silver nano particles encapsulated in amphiphilic, core, shell structures, antimicrobial silanes, polymers with an antimicrobial end group, polyquads with modified end groups, and biocidally acting block copolymers.

In the case of this method, the one or more components can be covalently bonded to the basic material or connected via a core, shell structure (core shell process) with the basic material.

The membrane can be formed, for example, by means of cold or hot lamination, screen printing, casting, extruding, film drawing or rolling.

The connection of the one or more components with the basic material can be performed in a solvent, especially toluene, cyclohexane, isopropanol, ethanol, diethyl ketone, dioxane, xylol, acetic acid ethyl ester or water. Alternatively, the connection can also be performed without a solvent.

The invention will now be described in greater detail on the basis of the appended drawing, the figures of which show as follows:

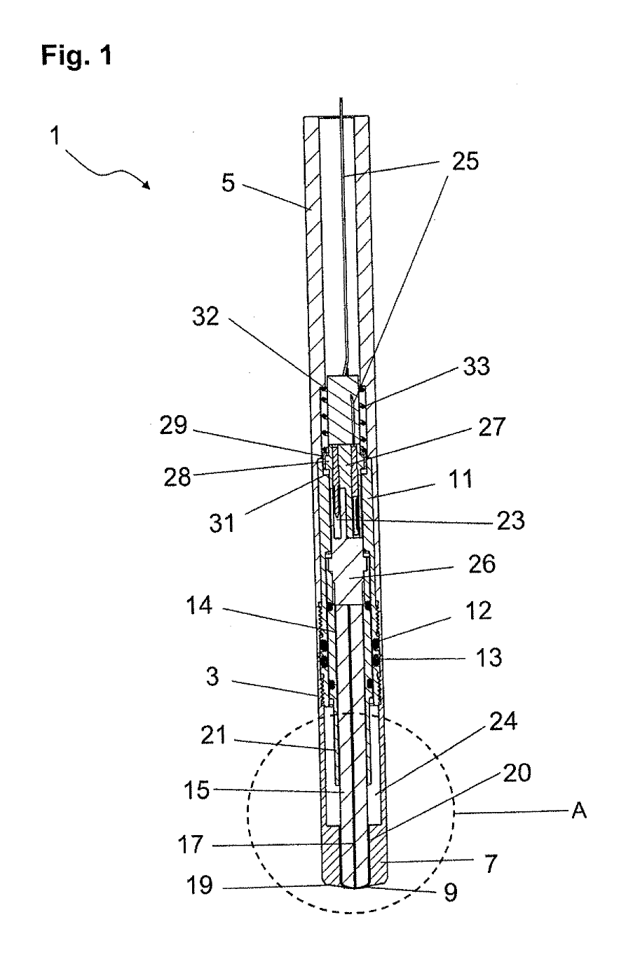

FIG. 1 a schematic representation of an electrochemical sensor, and

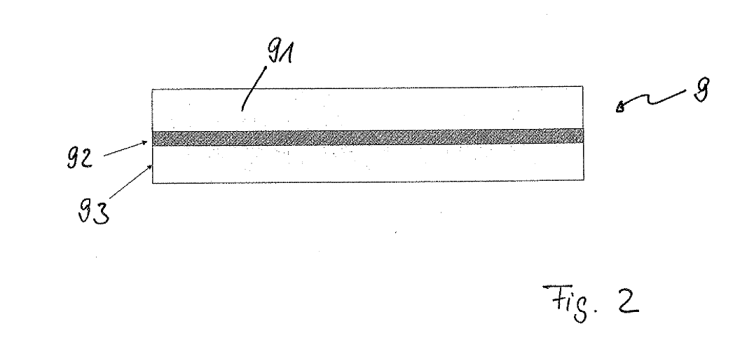

FIG. 2 a schematic representation of the membrane.

The sensor 1 shown in FIG. 1 in a longitudinal sectional representation can be used, for example, for amperometrically determining the O₂ concentration of a measured medium, especially a liquid containing O₂.

Sensor 1 has an essentially cylindrical shape and includes a membrane module 3, a sensor shaft 5 and a sensor plug head (not shown in FIG. 1) connected with the sensor shaft 5 on the connection end, wherein the measuring electronics of the sensor 1 is accommodated in the sensor plug head. In the following, the end of the sensor 1, on which the membrane is placed, is referred to as the “membrane end”, and the end of sensor 1 which lies opposite the membrane end is referred to as the “connection end”. Correspondingly, the direction toward the membrane end is referred to with “toward the membrane end” and the direction toward the connection end is referred to with “toward the connection end”.

Membrane module 3 includes a membrane cap 7 and a membrane 9. Membrane module 3 has in its end region toward the connection end an internal thread, which corresponds with an external thread of a central shell 11, and enables an easy screwing on of the membrane module 3 onto the central shell 11. Central shell 11 includes a further external thread arranged next to this first external thread on the connection end, which corresponds with an internal thread of the sensor shaft 5. For sealing the screwed connection between membrane module 3 and central shell 11 against the penetration of liquid, central shell 11 includes a groove for accommodating an 0-ring 13, adjoining the screwed connection toward the connection end. Correspondingly, central shell 11 has an additional groove adjoining its external thread toward the membrane end connecting with sensor shaft 5 for accommodating a second O-ring 12, wherein this O-ring 12 seals off the screwed connection between sensor shaft 5 and central shell 11.

The measuring electrode 14 of sensor 1 is formed by an electrode body 15 made of glass and, embedded along its axis, a wire electrode 17 made of platinum. If sensor 1 is, for example, embodied as an amperometric O₂ sensor, electrode 17 forms the cathode. Electrode 17 ends at an end face 19 of the measuring electrode 14. End face 19, embodied in the example shown here as a portion of a spherical surface—as a so-called spherical cap—is thus composed of mutually adjoining end faces of electrode body 15 and electrode 17.

The inner wall of the membrane cap 7 forms a passageway for the extension of measuring electrode 14, whose end 19, at least in a surface portion, contacts the membrane 9. This surface portion can be formed, for example, by a roughened or structured surface portion of the end face of electrode body 15. Between measuring electrode 14 and the inner wall of the membrane cap, an annular gap 20 remains, through which liquid can reach between membrane 9 and end face 19 of measuring electrode 14, and can especially reach between end face of electrode 17 and membrane 9.

On its side opposite the end face 19 of measuring electrode 14, electrode body 15 is surrounded by a sleeve-shaped second electrode 21, for example, an electrode made of silver. If sensor 1 is, for example, embodied as an amperometric O₂ sensor, the second electrode 21 forms the anode. Both the second electrode 21 as well as also electrode 17 are connected via a plugged connection 23 and connection lines 25 with the measuring electronics accommodated in the sensor plug head.

Membrane cap 7, the inner wall of the membrane module 3, central shell 11, the second electrode 21, measuring electrode 14 and membrane 9 thus completely enclose an electrolyte chamber 24 within membrane module 3. This electrolyte chamber 24 is filled with an electrolyte solution, e.g. an aqueous KCl solution, at least to such an extent, that the counter electrode 21 extends into the solution.

Through the annular gap 20 between membrane cap 7 and electrode body 15, the electrolyte solution also runs between end face 19 of measuring electrode 14 and membrane 9, and forms a thin electrolyte film there. This thin intermediate space between end face 19 of measuring electrode 14 and the membrane is occupied by electrolyte liquid and is referred to also as measurement space or electrolyte space 22. The roughening or structuring of end face 19 previously mentioned above assures that an electrolyte film forms, which is sufficiently thick for determining the analyte concentration. Alternatively, spacers, i.e. space holders, can also be provided between the electrode holder 15 and membrane 9, wherein the spacers can be embodied either as components of the electrode holder 15 or as additional components.

The plugged connection 23 is composed of a membrane end, plug element 26 connected with measuring electrode 14 and electrode 21, and a connection end, plug element 27 connected with the connection lines 25. The connection end, plug element 27 has a peripheral, annular protrusion 28, on which, toward the connection end, a metal sleeve 29 is axially supported, wherein the metal sleeve 29 tapers toward its connection end region, so that it sits on the annular protrusion 28 of plug element 27. If no membrane cap 7 is screwed on, annular protrusion 28 of the plug element 27 with metal sleeve 29 is supported axially on an annular area 31 of central shell 11, wherein this annular area 31 is formed via widening of the inner diameter of the central shell in direction of the connection end.

Via a wall structure, which is tapered on the connection end, the sensor shaft 3 forms an annular ledge 32, on which a helical spring 33 is axially supported. The helical spring 33 grips the metal sleeve 29 with its oppositely lying end toward the membrane end. The length of the measuring electrode 14 is selected in such a manner that in the case of a screwed on membrane module 3, the structural unit composed of measuring electrode 14, second electrode 21 and plugged connection 23, which is axially movable within the central shell 11, shifts toward the connection end of sensor 1. This effects that the annular protrusion 28 of the plug element 27 is lifted up from the annular area 31 of the central shell 11, and via the metal ring 29, exerts a force on the helical spring 33, and compresses this spring. The return force of the compressed helical spring 33 effects a compressive pressure of measuring electrode 14—which is connected via metal sleeve 29 and the plug elements 27, 26 with helical spring 33—against the membrane 9.

The membrane 9 is detailed schematically in FIG. 2. It is formed of a basic material, for example, a thermoplastic or a polymer, on which components, which bring about a biocidal effect of membrane 9, are covalently bonded, or are connected via a core, shell structure. In the example shown here, the membrane includes a first layer 91 on the side of membrane 9 facing away from the measured medium, wherein first layer 91 is composed essentially of the basic material. Furthermore, membrane 9 includes a layer 93 in contact with the measured medium, wherein this layer 93 is formed from the basic material of the membrane and incorporates components with biocidal or antimicrobial effects. Membrane 9 includes, moreover, a support structure 92. Support structure 92 can be, for example, a grate made of stainless steel or other inert material. In another embodiment of membrane 9, an option is that both the layer 91 facing away from the measured medium as well as also the layer 93 on the medium side comprise components with a biocidal effect. Depending on sensor type, the membrane can include other layers.

The components of membrane 9 with a biocidal effect can be, for example, one or more of the following components: silver nanoparticles encapsulated in amphiphilic, core, shell structures; antimicrobial silane, e.g. dOTPAC; a polymer with an antimicrobial end group; polyquads with modified end groups; or a block copolymer with a biocidal effect or another suitable compound. A sufficient durability of the biocidal effect of membrane 9 is achieved by the biocidal components being covalently bonded to the basic material of the membrane or by their being bonded in or on the membrane 9 by means of a core, shell structure.

Especially, the components with a biocidal effect mentioned here and above can be bonded to a polymer basic material, such as, for example, a single component or multicomponent silicone, epoxide resin, polyurethane, polyester, polysulfone, polystyrene, polyacrylate, carbon fiber composite material or other polymers, covalently or by means of a core, shell structure in such a resistant manner that even in the case of increased temperature loadings of membrane 9 or in aggressive media, the biocidal properties of the membrane are not lost.

Besides the embodiment of the sensor 1 described here in connection with FIG. 1, variations exist, which likewise operate according to the principle of producing a compressive pressure between the measuring electrode and the membrane with the assistance of elastic means. For example, as already previously described, elastic means act on the membrane either directly or via one or more other components, and press the membrane against the measuring electrode. Alternatively, both the measuring electrode as well as also the membrane can be connected with elastic means in such a manner that membrane and measuring electrode are pressed against each other.

Instead of the two electrode arrangement of the sensor illustrated in FIG. 1, a three electrode arrangement with a measuring electrode, a counter electrode and a reference electrode can also be provided. In this case, the counter electrode and the reference electrode can, for example, be embodied as metal rings, which, insulated from one another, surround the electrode body made of glass. Such an electrode arrangement is described, for example, in DE 42 32 909 C2. Additionally, still other auxiliary electrodes can also be provided within the electrolyte space.

In an alternative example of an embodiment of the invention, the sensor can be embodied as a potentiometric sensor, e.g. for concentration determination or partial pressure determination of CO₂ in a measured medium. The measuring electrode includes, in this case, a pH selective electrode, e.g. a pH glass electrode; or a pH selective semiconductor electrode, e.g. a pH ISFET electrode. The remaining sensor construction can, in this case, be embodied in a manner analogous to the example of an embodiment shown in FIGS. 1 and 2, wherein the measuring electrode can also be embodied as a single rod measuring chain. CO₂ diffusing through the membrane changes the pH value of the electrolyte in the electrolyte space or measurement space according to the equilibrium with hydrogen carbonate (Severinghaus principle). The pH value change is measured by means of the pH selective electrode, and therefrom, the CO₂ concentration of the measured medium is determined.

1-14. (canceled)

15. A membrane, especially a membrane for application in a sensor, which membrane includes a biocidal effect, and comprises:
one or more components of the group consisting of: silver nano particles encapsulated in amphiphilic, core, shell structures, antimicrobial silanes, polymers with an antimicrobial end group, polyquads with modified end groups, and biocidally acting block copolymers.

16. The membrane as claimed in claim 15, wherein:
the membrane is resistant against aggressive agents, for example, corrosive or oxidizing cleaning agents, in case of sterilizing, in case of autoclaving, in case of thermal loading and/or in case of mechanical loading.

17. The membrane as claimed in claim 15, wherein the membrane further comprises:
a basic material, especially a thermoplastic or an elastomer, to which said one or more components is or are covalently bonded.

18. The membrane as claimed in claim 15, wherein the membrane further comprises:
a basic material, especially a thermoplastic or an elastomer, in or on which said one or more components is or are associated via core, shell structures.

19. The membrane as claimed in claim 18, wherein:
said core, shell structures comprise polyamino acids, for example, polylysine, or their derivatives, or functional groups suitable for complex formation, such as, for example, thiol groups or amine groups.

20. The membrane as claimed in claim 15, wherein:
said amphiphilic, core, shell structures comprise one or more components of the group consisting of: amphiphilic polylysine derivatives, polyethyleneimine derivatives, polyglycerine derivatives, amphiphilic block copolymers, star polymers and comb polymers.

21. The membrane as claimed in claim 15, wherein:
said antimicrobial silanes include dimethyloctadecyl[3-(trimethoxysilyl)propyl]ammonium chloride (DOTPAC).

22. The membrane as claimed in claim 15, wherein:
the polymers with an antimicrobial end group comprise at least one polymer of the group consisting of: polyethelene glycol, polyoxazolines, polydimethyl siloxanes; and
quarternary ammonium compounds, phosphonium groups or sulfonium groups can comprise the antimicrobial end group.

23. An electrochemical sensor for determining concentration of an analyte, especially a gas in a gaseous or liquid, measured medium, wherein said electrochemical sensor has at least one electrolyte chamber separated from the measured medium by a membrane comprising:
one or more components of the group consisting of: silver nano particles encapsulated in amphiphilic, core, shell structures, antimicrobial silanes, polymers with an antimicrobial end group, polyquads with modified end groups, and biocidally acting block copolymers, especially a membrane serving as a diffusion barrier.

24. The electrochemical sensor as claimed in claim 23, wherein:
said electrochemical sensor is suitable for determining gaseous or highly volatile components, such as, for example, CO₂, O2, NH₃, H₂S, CO, HCl, HF, HBr, HI, NO, NO₂, NOx, H₂, SO₂, SO₃, CH₄, H₂, Cl₂, ClO₂, HClO, O₃, N₂O.

25. A method for the manufacture of a membrane comprising:
one or more components of the group consisting of: silver nano particles encapsulated in amphiphilic, core, shell structures, antimicrobial silanes, polymers with an antimicrobial end group, polyquads with modified end groups, and biocidally acting block copolymers, the method comprising the step of:
forming the membrane from a basic material, for example, a single component or multicomponent silicone, epoxide resin, polyurethane, polyester, polysulfone, polystyrene, polyacrylate, or a carbon fiber composite material, and one or more components of the group consisting of: silver nano particles encapsulated in amphiphilic, core, shell structures, antimicrobial silanes, polymers with an antimicrobial end group, polyquads with modified end groups, and biocidally acting block copolymers.

26. The method as claimed in claim 25, wherein:
said one or more components is or are covalently bonded to the basic material or is or are connected via a core, shell structure with the basic material.

27. The method as claimed in claim 25, wherein:
said membrane is formed by means of cold or hot lamination, screen printing, casting, extruding, film drawing, spraying, impregnating or rolling.

28. The method as claimed in claim 25, wherein:
the connection of said one or more components with the basic material is performed in a solvent, especially toluene, cyclohexane, isopropanol, ethanol, diethyl ketone, dioxane, xylol, acetic acid ethyl ester or water, or is performed without a solvent.
